(19) United States
(12) Patent Application Publication
(10) Pub. No.: US 2007/0087763 A1
(43) Pub. Date: Apr. 19, 2007

(54) Location aware wireless security

(75) Inventors: Ramakrishna S. Budampati, Plymouth, MN (US); Denis Foo Kune, St. Paul, MN (US); Steve D. Huseth, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/252,434

(22) Filed: Oct. 18, 2005

(51) Int. Cl. H04Q 7/20

(52) U.S. Cl. 455/456.5

(57) ABSTRACT

A secure wireless network system includes one or more wireless receivers that receive communications from wireless devices. The wireless receivers, or access points, include sensors that detect the location of a wireless device sending communications to the wireless receiver. A controller rejects access to the wireless network by a wireless device as a function of the location of the wireless device. In further embodiments, security information is combined with location information to form events. The events are correlated with known access attempt patterns to control access to the network.

### RELATED APPLICATION

Co-pending commonly assigned application Ser. No. 11/017,382, filed Dec. 20, 2004, entitled “INTRUSION DETECTION REPORT CORRELATOR AND ANALYZER”, which is hereby incorporated by reference.

### BACKGROUND

Hardwired networks have been protected by software which detects intrusion attempts by monitoring traffic on the network. Such software is fairly sophisticated, detecting different patterns of attacks. However, with the advent of wireless networks, intrusions may be attempted by anyone within range of the network. In other words, an intruder or attacker need not gain physical access to a network port, which may be easily protected by physical security measures. Instead, a potential attacker may be outside of a building that has a wireless network. Thus, the types of threats to a network may change, creating a challenge for appropriately protecting wireless networks.

### SUMMARY

A secure wireless network system includes one or more wireless receivers that receive communications from wireless devices. The wireless receivers, or access points, include sensors that detect the location of a wireless device sending communications to the wireless receiver. A controller rejects access to the wireless network by a wireless device as a function of the location of the wireless device.

### BRIEF DESCRIPTION OF THE DRAWINGS

FIG. 1 is a block diagram of a wireless access control system according to an example embodiment.

FIG. 2 is a more detailed block diagram of a wireless access control system according to an example embodiment.

FIG. 3 is a block diagram of an alternative embodiment of a wireless access control system according to an example embodiment.

FIG. 4 is a block diagram or yet a further alternative embodiment of a wireless access control system according to an example embodiment.

FIG. 5 is a screen shot illustrating an example of a possible virus attack according to an example embodiment.

FIG. 6 is a block diagram of location calculation using time difference of arrival according to an example embodiment.

FIG. 7 is a block diagram of location calculation using time received signal strength according to an example embodiment.

FIG. 8 is a block diagram of location calculation using angle of arrival information according to an example embodiment.

FIG. 9 is a text representation illustrating tasks performed by various elements of the wireless access control system in response to attempted access to a network according to an example embodiment.

FIG. 10 is a text representation illustrating tasks performed by various elements of the wireless access control system in response to attempted access to a network where the client is located in an unauthorized area according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

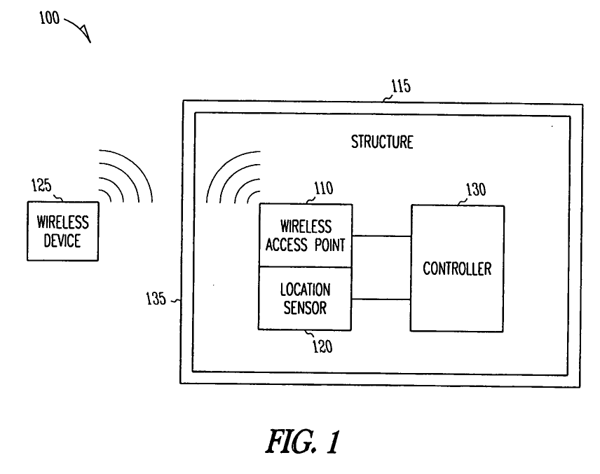

A location aware wireless security system is illustrated generally at 100 in FIG. 1. A wireless access point 110 is operating within a structure 115, such as a home or commercial building. The wireless access point 110 includes a receiver or transceiver that receives and transmits wireless signals within the structure 115, as well as outside the structure 115. In one embodiment, it is desired that only users within the structure can connect and receive and transmit signals to and from the wireless access point 110. A location sensor 120 is used to determine the location of a user, such as in this example embodiment, a user 125 located external to the structure 115. The location sensor 120 is shown adjacent or as part of the wireless access point 120, but may be located within or outside structure 115 to sense the location of a user attempting to connect via wireless access point 110. In one embodiment, the wireless access point is accurate enough to detect generally whether a user is within or outside the structure. An accuracy of six inches or less is desirable, but not required for operation. In further embodiments, the location sensor 120 detects the location of a user within the structure.

The wireless access point 110 and location sensor 120 are coupled to a controller 130 that contains logic that uses the location information and user information to determine whether or not to grant the user access to the wireless access point 110 and a network (not shown) that is coupled to the wireless access point 110. The controller 130 implements a method to reject access attempts from users detected outside the structure 110. It may also reject access attempts from users within the structure, such as those within public areas in the structure.

The controller 130 implements methods that provide the ability to recognize and respond to threats to an information system that are a result of “through the walls” wireless access, where users are mobile and rapidly connect and disconnect from the network. Access control policies may be extended for information systems by enabling modulation of an individual's access permissions based on where the user is physically located. Location sensing in one embodiment does not require any additional specialized hardware or software on the user wireless device, such as a laptop, or other wireless or WiFi device. In one embodiment, location detection techniques may involve ultrasound, RF time of arrival, etc. Many different location detection techniques may be used.

In one embodiment, location resolution is approximately +/−6 inches, making it possible to determine if a person is inside or outside a particular secured region or area. This is about the thickness of an average wall. The location sensing access point in a further embodiment may be able to identify the location of clients as well as other access points. The access point or system may provide specialized countermeasures to WiFi attacks such as signal jamming and disabling or ignoring certain communication attempts at the access point. The system may provide an extensive event logging and event analysis capability to support forensic investigations. The system may also recognize low-level WiFi attacks such as abnormal traffic patterns, excessive traffic generation, media (or medium) access control (MAC) address spoofing, and repeated authentication requests.

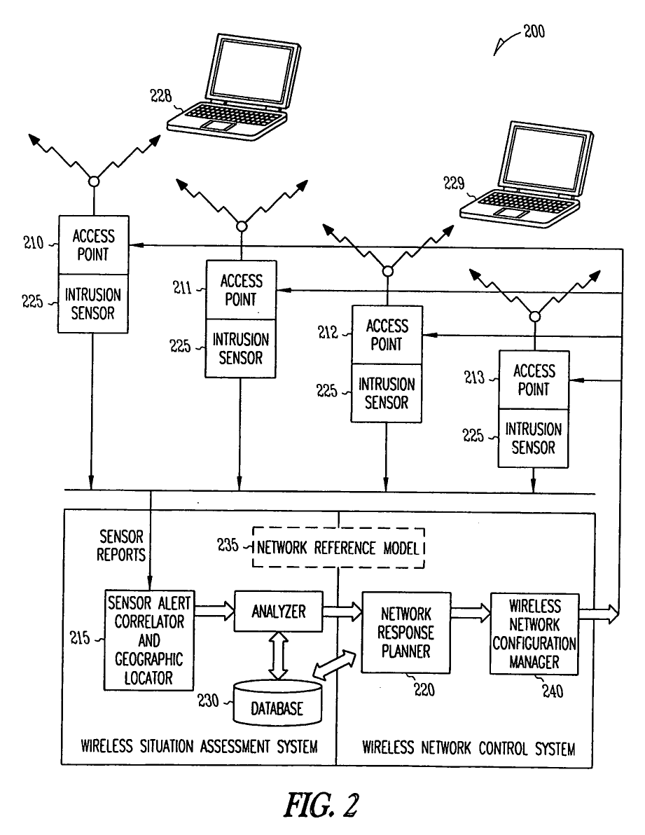

In a further embodiment illustrated in FIG. 2, a location aware WiFi security (LAWS) system 200 consists of three major capabilities: location awareness, event analysis, and response. Location awareness will be provided by specialized access points (AP) 210, 211, 212, and 213 that are distributed around a facility and that feed information to a sensor alert correlator/geographic locator 215 and then to a Response Manager 220 to produce an action. Access points are devices, such as wireless modems, that contain function to identify location information via location sensors 225 for WiFi clients 228 and 229 attempting to communicate with them. Location information is passed to the correlator and geographic locator 215 to be aggregated with information from other APs to compute a more accurate client location. The correlator and geographic locator 215 also uses disparate pieces of location data with a location database 230 to map physical space. Policy information in a reference model 235 is used to determine when a client identified in a particular area is significant. Events indicating a change in access policy or possible threat are passed to a wireless network configuration manager 240 which determines which actions the system should take and generates responses to the APs. Responses may include changing the access control policy on the client, sending an alert to a management console, or commanding APs to invoke specific countermeasures.

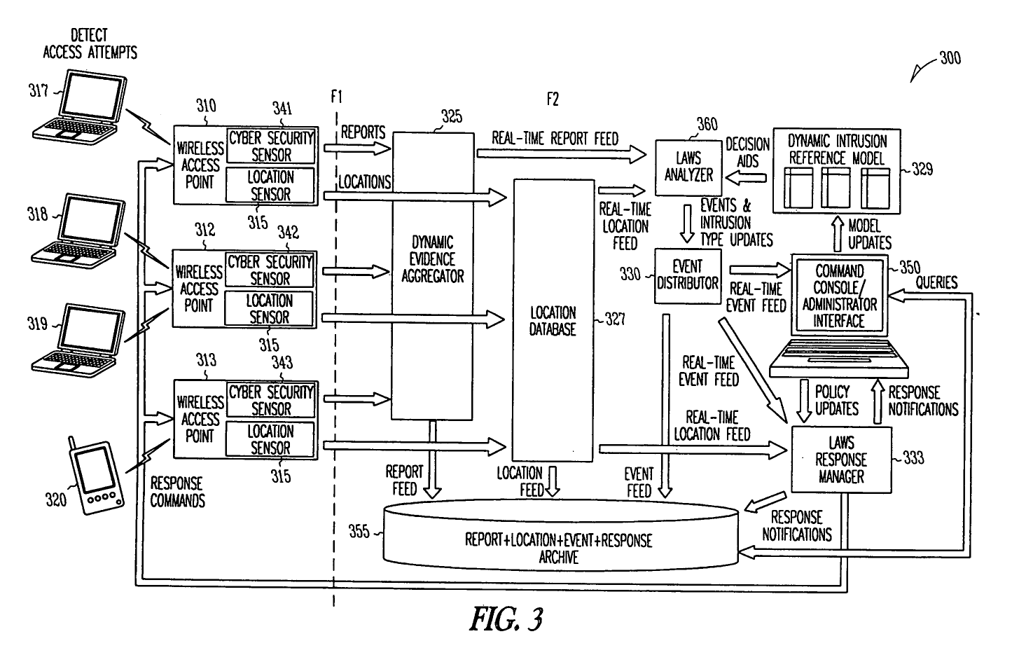

In a further embodiment illustrated in FIG. 3, a location aware WiFi security (LAWS) system 300 consists of three major capabilities: location awareness, event analysis, and response. Location awareness will be provided by specialized access points (AP) 310, 311 and 312 that are distributed around a facility and that feed information to a dynamic evidence aggregator 325 and then to a response manager 333 to produce an action. Access points are devices, such as wireless transceivers, that contain function to identify location information via location sensors 315 for wireless, such as WiFi clients 317, 318, 319 and 320 attempting to communicate with them. Clients may be any type of device, such as a laptop computer, personal digital assistant, or any of a number of devices capable of communicating wirelessly.

Location information is passed to a dynamic evidence aggregator 325 to be aggregated with information from other APs to compute a more accurate client location. The aggregator 325 also use disparate pieces of location data with a location database 327 to map physical space. Policy information in a reference model database 329 is used to determine when a client identified in a particular area is significant. Events indicating a change in access policy or possible threat are passed by an event distributor 330 to a response manager 333 which determines which actions the system should take. Responses may include changing the access control policy on the client, sending an alert to a management console 335, or commanding APs to invoke specific countermeasures.

The APs may be able to produce significant amounts of information about clients and other unknown APs discovered by the system by use of cyber security sensors 341, 342, 342. These sensors may collect data such as MAC address, timestamp, time span, traffic patterns, exploitation attempts etc., which is augmented with location information from the location sensors. Each AP will be able to collect information from a single location in the network. By collecting and integrating the information produced by multiple APs, the accuracy and completeness of the information can be substantially increased.

The security sensors provide reports to the aggregator 325, and the location sensors feed data directly to location database 327. In general, normal traffic is ignored, however, log in/off and bad use patterns are reported. The location database 327 receives reports from aggregator 325 and real time location information from location database 327. In one embodiment, the aggregator only feeds information to the analyzer 360 if the location is unauthorized. However, analyzer 360 may also request location information as desired.

If a malicious access request occurs, the correlator 325 will classify the event using location information from the AP and pass the digested information to the response manager 333. The response manager 333 will command the APs to adopt appropriate countermeasures, such as denying network access to the user. In addition to changes to conventional IP message blocking rules, this network access denial may also include changing RF coverage areas, monitoring the user's behavior for future threats, or jamming the unwanted client or illicit access point.

An administrator 350 will be able to update the cyber reference model 329 when the access region changes or if the access control policy changes. The administrator will also be able to query a database 355 about all the events observed by the system for forensic analysis. Database 355 is fed reports from the aggregator 325, location database 327, event distributor 330 and the response manager 333.

System 300 aggregates information from multiple intrusion detectors and utilizes reports to reduce the high false alarm rate experienced by individual detectors. An internal representation of a protected enclave is utilized, and reports are correlated to accurately prioritize alerts. The correlation performed by an analyzer 360, may make use of a Bayesian estimation network and calculus based on qualitative probability in one embodiment. It uses the intrusion reference model 329 that contains information about the protected network, its configuration, installed intrusion detection systems and related security goals. In one embodiment, the model is an object model using a hierarchy of objects to represent the model. Further information about the analyzer and intrusion reference model may be found in co-pending commonly assigned application Ser. No. 11/017,382, filed Dec. 20, 2004, entitled “INTRUSION DETECTION REPORT CORRELATOR AND ANALYZER”, which is hereby incorporated by reference.

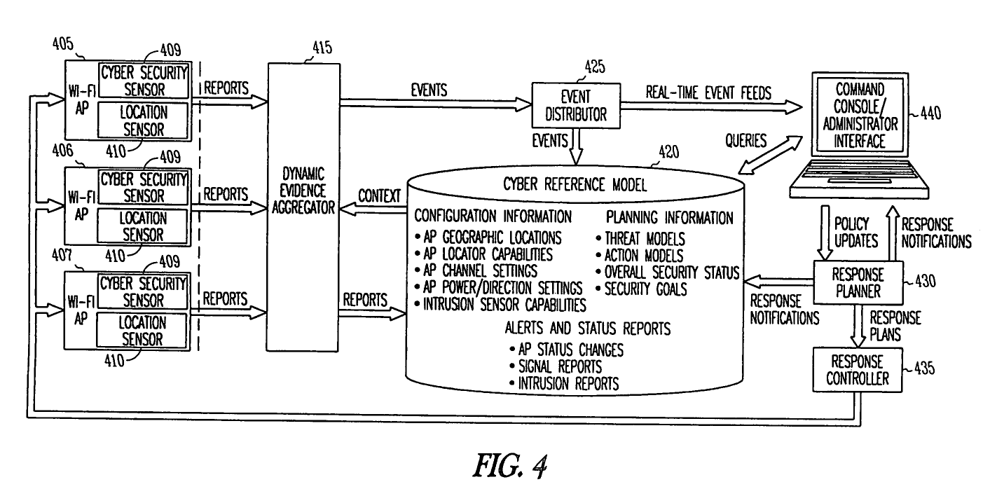

FIG. 4 depicts a further embodiment of a LAWS wireless network intrusion detection and response environment generally at 400. Each access point 405, 406 and 407 is augmented with facilities to locate WiFi signal sources via location sensors 409 and analyze the information received for address and authentication information via security sensors 410. Reports from multiple AP sensors are sent to a Correlator's Dynamic Evidence Aggregator 415 where they are correlated. Events common to one or more reports are identified and stored in a database 420 along with the corresponding sensor reports. This guarantees that a security analyst can access both raw sensor reports and more abstract events. This capability is useful when performing forensic analysis. The Dynamic Evidence Aggregator 415 will correlate the location information provided by the APs with physical map data to identify significant areas of the building. Events may be simple or complex and may represent several levels of abstraction. This process can be expected to reduce thousands of reports to a few events worthy of a response. Events that are deemed significant are sent via an event distributor 425 to a response planner 430 which sends commands to a response controller 435 to respond to a new threat. A command console/administrative interface 440 is provided to allow updating policies, receive real-time event feeds and response notifications to help in administering the system.

Models may play an important role in the above environment. Sensor models record the location accuracy of each AP as well as the strengths and limitations of any other information sensors, including report accuracy and richness. Models of the wireless environment provide information on signal strength, channel assignments, and access point geographic locations. Models of the protected network provide information on operating systems and services in use, patch levels, vulnerability to attacks, and potential attack propagation paths. Event models that define abstractions that reduce information overload and provide alternative explanations at various levels. It is possible that an event may include location information that places a client within the structure, yet still rejects access. It is also possible that an event may include location information placing a client outside the structure, or unauthorized are, yet still allows access.

The Correlator fuses data from multiple APs and relates them to a coherent set of events using information about the AP and other sensor characteristics contained in a knowledge base. Events are analyzed using information about the wireless environment and defended assets, security goals, and mission goals in a knowledge base. This information is of sufficient quality for the delicate task of automated response.

The analysis engine employs several techniques, the most powerful of which is modeling the environment and sensors with a common ontology, the cyber reference model (CRM) 420. The sensor modeling portion of the CRM allows assembly of reports into consistent cyber situation hypotheses. An example sensor model for a popular SNORT (a shareware intrusion and detection system—http://www.snort.org/docs/snort_manual.pdf) intrusion detection system (IDS) is illustrated in FIG. 5 at 500. Each instance of a possible alert that SNORT (or other sensor) can emit is shown in a center column 505, and interpretations of that alert are cataloged in a right window 505 for the sensor model. The position of the windows may be varied as desired.

The central decision-making technology for responding to significant events detected by the Dynamic Evidence Aggregator is the Response Manager which is built on CIRCADIA technology. CIRCADIA is a specialization of proven CIRCA (Cooperative Intelligent Real-time Control Architecture) technology for use in information assurance domains. CIRCA is a cooperative architecture that uses separate AI and real-time subsystems to address the problems for which each is designed. CIRCADIA has three levels of intelligence that operate concurrently at progressively higher levels of cognitive sophistication and temporal extent:
The RTS (Real Time System) reacts to sensor and external inputs in real-time to achieve mission goals.
The planner generates real-time plans that maximize expected mission utility.
The meta-planner reflectively reasons about the deliberative effort required to synthesize plans and parcels reasoning resources effectively.

CIRCADIA provides critical technology to meet the challenges of the increasingly dangerous and unpredictable wireless network environment. The response manager will react in real-time to changes in the activities of adversaries. To accomplish this, the response planner will make tradeoffs between service priorities and adapt to different security contexts. Examples of this tradeoff include minimizing nuisance attacks from “script kiddies” when at low levels of alertness or focusing the full attention of the security system on maintaining the availability of a handful of services critical to operation during high alert levels.

Rather than building a security control algorithm or rule base by hand, one embodiment of the response planner requires only models of the network to be protected, the threats it may face, and the available defensive actions. CIRCADIA technology automatically, dynamically creates and executes response controllers that respond immediately to attacks. As the available resources change, threat levels vary, and security policy change, the response planner will automatically build new controllers tailored to the current situation, maximizing both the flexibility and effectiveness of the overall wireless network. Furthermore, since system administrators need only provide models of the wireless network configuration and threats (rather than the security control algorithms themselves), maintaining autonomic security will be much lower in cost and less error-prone than alternative rule-based approaches. It will be easier to install and easy to update as adversary capabilities and strategies change.

The response planner uses three main components to provide its intelligent real-time wireless network security control:
Real-time System (RTS) that guarantees real-time responses. The RTS reliably executes monitoring and response reactions that the planner derives automatically.
Planner that synthesizes reactions to expected adversaries. The planner synthesizes reactions specific to expected adversarial security attacks and to the configuration that the meta-planner, with its broader scope, provides. The planner performs all of the complex reasoning about interactions between actions, temporal transitions, external events, and the time ranges within which reactions must occur to guarantee their performance.
Meta-Planner determines response priorities. The meta-planner takes into account broader-range contextual information, such as changing goals/policies from system administrators (e.g., cybercon, computational mission), system-wide resource constraints, and effects of earlier mitigating response actions, to constantly re-evaluate and determine system priorities for the planner.

CIRCADIA may be built on the proven CIRCA architecture for intelligent real-time system control. CIRCA's model of real-time actions and environments support concurrent execution of real-time control instructions and reasoning about real-time requirements. The original CIRCA architecture was designed to support both hard real-time response guarantees and unrestricted AI methods that can guide those real-time responses. In the original CIRCA architecture, the planner reasons about high-level responses that require its powerful but potentially unbounded planning methods, while a separate real-time subsystem (RTS) reactively executes the planner-generated plans and enforces guaranteed response times. CIRCA has been applied to real-time planning and control problems in various domains including mobile robotics and simulated autonomous aircraft.

CIRCADIA's planning and execution subsystems operate in parallel. The CIRCADIA planner develops executable control plans that will assure system security and attempt to achieve system goals when interpreted by the RTS. The planner reasons about an internal model of the world and dynamically programs the RTS with a planned set of reactions. While the RTS is executing those reactions, ensuring that the system avoids failure (i.e. a security breach), the planner is able to continue executing planning methods to find the next appropriate set of reactions. The derivation of this new set of responses does not need to meet a hard deadline, because the responses concurrently executing on the RTS will continue handling all events, maintaining system security. When the new controller (reaction set) has been developed, it can be downloaded to the RTS. The planner builds control plans based on a world model and a set of formally-defined conditions that must be satisfied by feasible plans.

CIRCADIA domains are described by a set of transition descriptions that implicitly define the set of reachable states. The planner builds plans by generating a nondeterministic finite automaton (NFA) from these transition descriptions. The planner assigns an action to each reachable state. These actions are selected to drive the system towards states that satisfy as many goal propositions as possible and to preempt transitions that lead to failure. Action assignments determine the topology of the NFA (and so the set of reachable states). Preemption of temporal transitions removes edges and assignment of actions adds them. System safety is guaranteed by planning action transitions that preempt all transitions to failure.

At the end of this process, the NFA generated by the planner enumerates the actions planned by the planner and the unpreempted external transitions. The control plan for the RTS can be extracted from the set of planned actions in the NFA. This ability to build plans that guarantee the correctness and timeliness of safety-preserving reactions makes CIRCA suited to mission-critical applications in hard real-time domains.

To successfully provide accurate responses to hostile clients, accurate models of the wireless network configuration, threats, and mission priorities must be created. To accomplish this task, existing modeling language may be extended to represent concepts, such as the relative value of competing mission responsibilities, which were not required in previous applications. These new concepts can be divided into three broad categories: the cost of enabling certain sensing activities (e.g. increasing the sensitivity of an access point), the values of different network services, and the likelihood of sequences of actions taken by an adversary.

In the wireless domain, increased sensing (e.g. analysis of all signals received by an access point set to maximum sensitivity) often increases costs. Any attempt to use the information is foiled by the effort of filtering it. Furthermore, increased sensitivity opens up the possibility of denial-of-service attacks that swamp the logging facility. Using a model that makes the costs and limitations of sensors explicit, the planner will build plans that only initiate expensive sensing behaviors when they are warranted.

To make proper decisions balancing the costs and risks of maintaining access to different wireless services, the modeling language will represent the values of services. These value functions could be a strict relative ordering between system goals, in which case the planner will maximize expected value to the system's customers by attempting to maintain the supply of each service in rank order. This approach lends itself to an iterative, anytime-planning paradigm (i.e., first develop a plan that achieves the highest ranked goal, then develop a plan that achieves the two highest ranked goals, and so on).

A more complex system for calculating expected value might be more useful. Again, an iterative planning approach could be employed, but finding the optimal strategy for planning becomes more complex as the language for expressing the value function becomes richer.

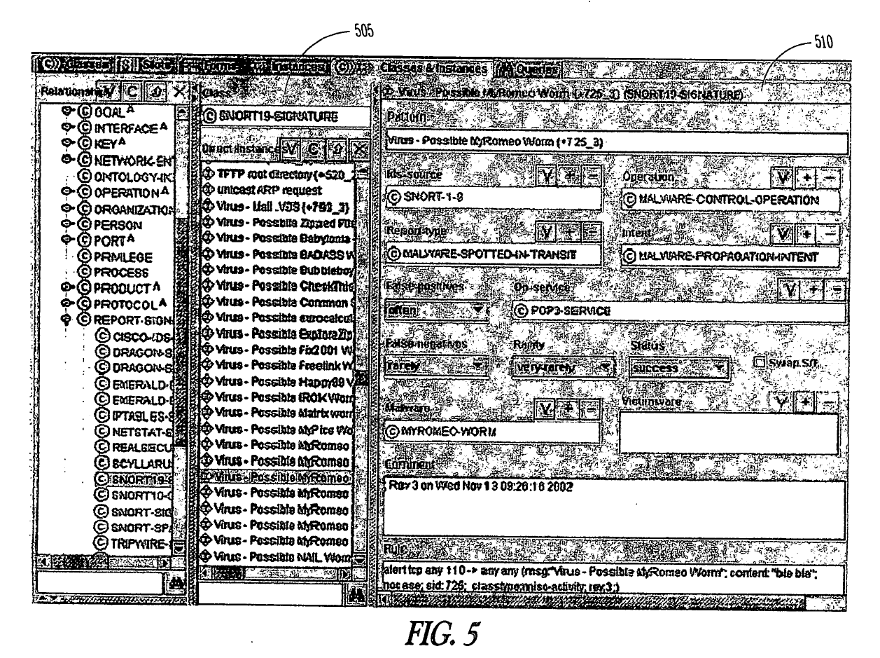

One element of the LAWS architecture is its ability to accurately pinpoint where a WiFi client is physically located within a building or facility. Further embodiments of the access point (AP) may act upon a number of location identification strategies. These strategies may be blended in the AP to provide the best estimate of the client's location. It may combine ranging data from multiple APs that have each have picked up the signal from the client to form a complete, high precision fix on the clients location. Several localization techniques are described with reference to FIGS. 6, 7 and 8.

Localization techniques in wireless networks can be broadly divided into two classes: traditional and non-traditional approaches. Traditional techniques have been used for localization in other settings, most often in systems whose primary goal was localization and ranging. Non-traditional approaches started to emerge in the 1990s to add localization capabilities, such as e-911 services, to communication networks. All these approaches to localization face challenges from the channel characteristics encountered in wireless local area network settings. In one embodiment, any of these approaches may be used, provided they generally provide the accuracy desired for adequate location detection, despite identified shortcomings.

The radio propagation channel used in WLANs is characterized by variability across sites and severe multipath reflections of the wireless signal. Furthermore, the direct line of sight (LOS) signal propagation path between the transmitter and receiver may be missing in several returns. Both multipath fading and the absence of the LOS component lead to large localization errors in WLANs. For example, in some returns, the non-line-of-sight component (NLOS) may have a larger amplitude than the LOS component. Therefore, a system that locks on the dominant return can produce the wrong range estimate. In other cases, the strength of the LOS component may be below the minimum detecting threshold. The receiver would then miss the shortest path between transmitter and receiver and once again produce an incorrect range estimate.

Statistical models of the channel may be used to predict the performance of the localization algorithm and guide the algorithm development and refinement. Furthermore, many localization algorithms rely on a statistical model of the channel. While many models have been developed for analyzing communication systems, they do not necessarily capture the channel parameters that have the greatest affect on localization performance. These parameters include the relative power and time of arrival of the direct LOS, relative power and time of arrival of the other paths, probability of missing the direct LOS, and time dependence of the channel statistics. Few radio channel models have been developed specifically for localization. Furthermore, separate experiments have arrived at different distributions for some of the parameters, such as the received signal strength, that are important in localization.

The most common localization techniques used in WLANs and cellular networks are the time of arrival (TOA), time difference of arrival (TDOA), received signal strengths (RSS), and angle of arrival (AOA) methods. These techniques were initially developed in the context of ranging and localization applications, such as passive or active radar and sonar. They rely on estimating the range between transmitters and receivers, typically from time measurements. The location of the receiver or the mobile station of interest can be computed based on a set of range measurements. The underlying assumption is that the received signals propagate through LOS paths. Violating this assumption introduces NLOS errors in range measurements, leading to erroneous location estimates.

In the TOA technique, the range to a given transmitter is estimated from the arrival time of the first arrival. The approach assumes that the earliest arrival corresponds to the LOS path. In the TDOA approach shown in FIG. 6, the system determines the difference between the times at which the signal is received at several distributed receivers. Each time difference defines a hyperbola on which the transmitter must lie. The intersection of the hyperbolae gives the source location estimate. Both the TOA and TDOA methods require perfect synchronization among many nodes, e.g., the transmitter and receivers in TOA method and all receivers in TDOA approach. The accuracy of the approaches depends on the accuracy of the time of arrival measurements. This is a function of the bandwidth of the transmitted signal and its time duration, or equivalently the number of returns that are processed to produce the range estimate.

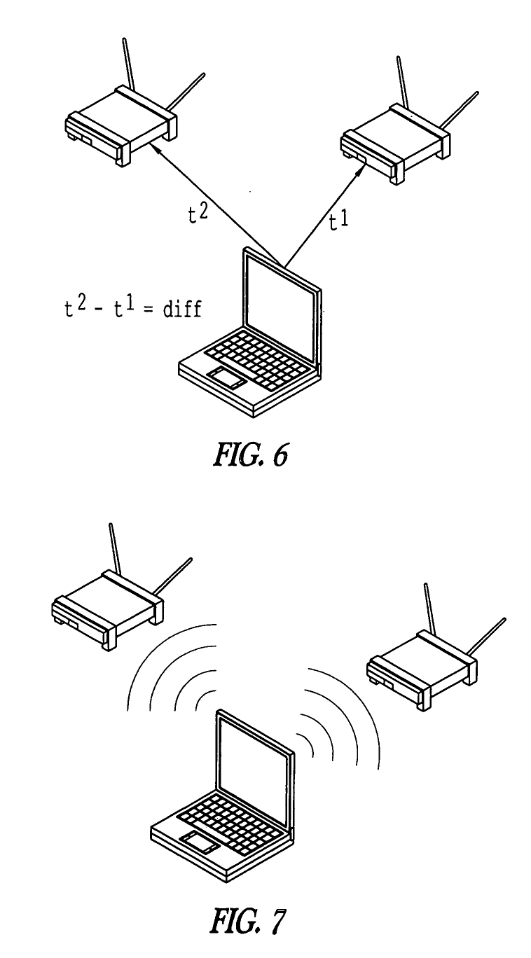

The received signal strength (RSS) FIG. 6 and angle of arrival (AOA) FIG. 7 methods do not require synchronization among nodes. In the received signal strength technique, the propagation path loss from the transmitter to a number of receivers is measured. These measurements are converted to distances based on a model of the dependency of propagation path loss on distance. For 2D positioning, each RSS measurement provides a circle, centered on the corresponding receiver, within which the transmitter must lie. In the absence of measurement error, the transmitter position is given by the intersection of the circles derived from measurements taken by at least three receivers. This approach offers poor localization in the complex multipath radio propagation environments characteristic of WLANs.

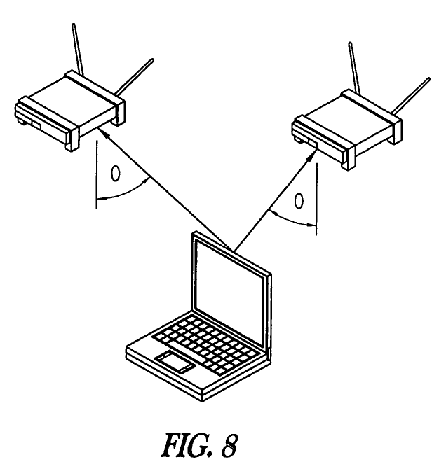

The AOA method illustrated in FIG. 8 uses an antenna array at each receiver. By using beamforming techniques, this method determines at each receiver a line in the direction of the angle that joins the transmitter and the receiver, called the line of bearing (LOB). With two or more AOA measurements from multiple receivers, the location estimate of the transmitter is obtained as the intersection of LOBs. The method is limited by antenna array calibration issues.

Several enhancements to these techniques may be included. For example, super-resolution spectral estimation methods may be applied to direct sequence spread wideband communications signals to enhance time of arrival or time difference of arrival estimates, improving ranging accuracy. Enhanced techniques for dealing with the NLOS problem include using the time history of the range measurements together with smoothing techniques (Kalman filtering, polynomial fitting, etc.) or a hypothesis testing approach and a knowledge of the standard deviation of the observation noise to determine whether a measurement corresponds to a LOS or NLOS path. Another class of enhancements relies on scattering models derived from site specific measurements.

Finally, enhancements to the RSS technique rely on a combination of prior measurements taken within the site of interest (at appropriately selected locations that are determined from the geometry of the site), a model of the site that can be used for electromagnetic simulations, and a Bayesian inference method for localization from the measured RSS at three or more base stations.

In addition to the described enhancements that focus on NLOS detection and mitigation at a single receiver, several techniques may be used to deal with the NLOS problem at the measurement fusion step. That is, they focus on the point where, for example, the intersection of the circles computed in a TOA approach are evaluated. These techniques rely on the availability of more receivers than the minimum required to unambiguously locate the client transmitter. They mitigate the effect of NLOS by computing the transmitter position using the subset of the available receivers that yield the lowest residual error.

The service area of a WLAN may be limited to the inside and close vicinity of a building. It is therefore feasible to optimize the placement of the base stations. It is also possible to conduct measurement campaigns to determine the RSS, TOA, and AOA observed from different base stations for different locations within or immediately outside the building. This observation has led to the development of a class of location fingerprinting techniques that could be considered extensions of the enhanced RSS method. The basic operation of pattern recognition positioning algorithms is simple. Given a fingerprint, e.g., a set of measured RSS, TOA, and/or AOA, the algorithm searches a database of location fingerprints for the closest match. The algorithm then returns the location of that closest match as the location of the transmitter. The database of location fingerprints is populated by dividing the service area into non-overlapping cells, analyzing the received signal patterns corresponding to each cell and recording the corresponding fingerprint in the database. Several variations on this simple approach have been successfully demonstrated in limited service areas. Indeed, the major limitation of this class of techniques is that it does not scale easily, requiring larger databases and becoming more prone to errors that are due to different locations displaying close signatures because of the small scale fluctuations observed in radio propagation.

Although each of the techniques above can provide some accuracy in locating a rogue source, individually they may not permit achieving desired performance goals under a usefully broad range of conditions. In one embodiment, the measurements are blended in a statistically optimal way.

In addition to blending or fusing the TDOA, RSS, and AOA measurements, idiosyncratic aspects of the environment and the deployed system infrastructure may be accounted for. These aspects are relevant for estimating location from any one of these signals. Electromagnetic obstacles, reflections, disturbances, and other complexities of realistic applications may be substantially managed.

In one embodiment, the approach is an empirical one, in which sample data is collected by mimicking the operation of a rogue node. Thus a WiFi source can be used to transmit from different locations, within and outside the building and at different transmit power levels. The measurements can be collected for each transmit event. The collected data becomes a sample set for developing a statistical estimator. The parameters associated with the samples (location, power level, other sources of variation) may be selected randomly for each sample—this randomization effectively overcomes the curse of dimensionality that would result from a discrete grid-based experimental design.

Many statistical approximation methods may also be used, but some important characteristics of the problem should be taken into account. In particular, the technique should be scalable since the number of measurements to be processed can be large (perhaps up to 100). In addition, the optimal estimation function will probably be nonlinear and its analytic form may not be determined or suggested in advance. A multilayer perceptron neural network may be the most effective statistical approximator.

A sample set may be used for training the neural network and standard methods (e.g., early termination, splitting of the sample set into training and validation subsets, use of a low-complexity network architecture) employed to ensure against overfitting. After the training the expected accuracy of the network may be predicted for location prediction. If accuracy is insufficient, additional sensor nodes, training data, and other modifications can be performed and the process rerun.

Training is unlikely to be protracted; most of the time will be spent compiling the data set—for a reasonable-scale office building this could be done in less than one day. The neural-network training time is not likely to exceed an hour or so (several advanced learning algorithms are available and will be used instead of the basic gradient-descent approach).

Once successfully trained, a neural network with TDOA, RSS, and AOA measurements as inputs can be used to estimate the location of an unknown source. Note that significant (RF-visible) changes to the building or to the sensor set will result in a loss of accuracy; this can readily be ameliorated with retraining. In fact, we would recommend regular system testing-collecting a few samples weekly or monthly (as for collecting the training data set) to verify the accuracy of the neural-network approximator. Training can be reinitiated as desired or when structural changes are made to the environment.

Several complications may occur. In practice, all measurements may not be available under all conditions. For example, the TDOA measurement depends on clock synchronization which may depend on whether the source message is time-stamped and on whether some other synchronization trigger is operational at some point in time. Similarly, the AOA measurement may not be useful if the phased-array antenna is unable to identify the source direction. The approach allows source locations to be estimated with subsets of the full measurement set. This is easily realized by training independent neural networks with different input signals. The same sample set can be used in all cases—for the subset-input networks some variables in the sample will be ignored. Since these multiple neural networks can all be trained in parallel there will be minimal additional training time required. For example four neural networks may be trained—one with the full complement of inputs, one with TDOA and RSS measurements, one with RSS and AOA measurements, and one with just RSS measurements.

In addition to location detection capabilities, the APs may also contain custom intrusion detectors/sensors that generate sensor reports on received signals. The AP is uniquely capable of detecting a variety of abnormal traffic patterns, excessive traffic generation from a single source, MAC address spoofing, and repeated authentication requests. This additional channel analysis information will be combined with the location data and sent to the Correlator and Geographic Locator for further evaluation and correlation with other AP inputs.

Potential countermeasure strategies may be employed in response to either rogue clients or other APs. These techniques include:
1) Jamming rogue clients using focused beam forming signals from a phased array antenna or a gimbaled jamming antenna
2) WiFi MAC/PHY layer blocking of messages,
3) Power managed transmissions to the client to transmit at the lowest power required for the client to receive the communication, and
4) Repeatedly sending Disassociate or Deauthenticate control frames to disconnect the rogue client from any APs it may have attached to.
   Each of these functions will be available to be used to counter threats against the WiFi network as they are detected and provide a real-time response as directed by the Response Controller.

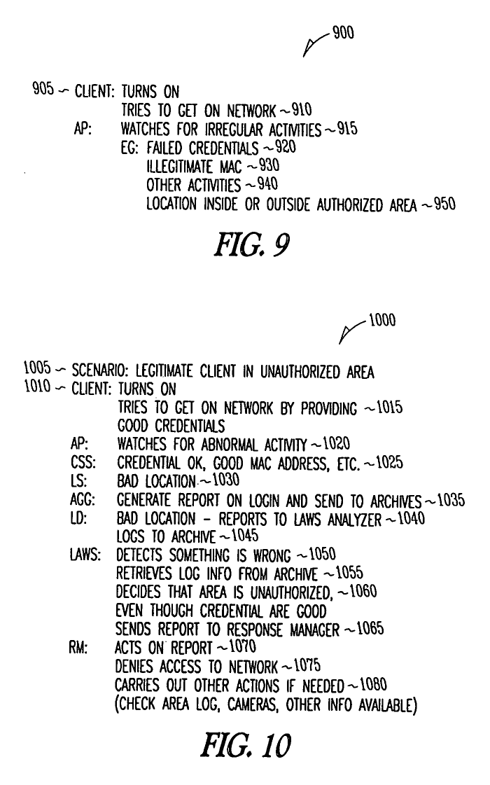

FIG. 9 illustrates activities performed by various embodiments of the location aware security system generally at 900. At 905, a client turns on and tries to sign on to the network at 910. The access point or points, AP, watch for irregular activities at 915. Examples of irregular activities include failed credentials 920, illegal MAC address 930, or other illegal activities 940, as well as whether the client is located outside an authorized area at 950. Access may be denied for any of these irregular activities directly, or via a LAWS analyzer using the reference model.

FIG. 10 at 1000 illustrates a process followed give a scenario 1005 of a legitimate client attempting to access the network from an unauthorized area. The client turns on at 1010 and tries to log onto the network at 1015 using valid credentials. At 1020, access points watch for abnormal activity. The cyber security sensor 341 determines that the credentials are good at 1025, but the location sensor determines that the location is bad at 1030. This information is passed on to the aggregator 325, which generates a report that is sent to the archives at 1035. At 1040, the location database 327 receives the bad location information and sends it to the LAWS analyzer 360. The location database also logs it in the archive at 1045.

At 1050, the LAWS analyzer detects that something is wrong, and retrieves log info from the archives at 1055. It decides that the log information was correct, but the location information showed the attempt to log in was from outside the authorized area at 1060. A report is sent to the response manager at 1065. The response manager acts on the report at 1070, and denies access to the network at 1075. At 1080, the response manager carries out other actions if needed. It may check an area log, cameras, or other available information.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A wireless network system comprising:
a wireless receiver that receives communications from wireless devices;
a sensor that detects the location of a wireless device sending communications to the wireless receiver; and
a controller coupled to the detector that rejects access to the wireless network by a wireless device as a function of the location of the wireless device.

2. The wireless network system of claim 1 and further comprising multiple wireless receivers and sensors.

3. The wireless network system of claim 2 wherein location of a wireless device is a function of information obtained from multiple sensors.

4. The wireless network system of claim 3 wherein the location of a wireless device is determined by at least one of time difference of arrival, received signal strength and angle of arrival.

5. The wireless network system of claim 4 wherein a neural network is used to determine the location of a wireless device.

6. The wireless network system of claim 1 and further comprising means for employing countermeasures in response to unauthorized wireless devices.

7. The wireless network system of claim 1 and further comprising a map of physical space representing authorized areas, and wherein access is rejected if the wireless device is outside an authorized area.

8. The wireless network system of claim 1 and further comprising cyber security sensors that provide information about wireless devices attempting to access the network.

9. The wireless network system of claim 8 wherein the cyber security sensors provide information selected from the group consisting of MAC address, timestamp, time span, traffic patterns, and exploitation attempts.

10. A wireless network system comprising:
a wireless receiver that receives communications from wireless devices;
a detector that detects the location of a wireless device sending communications to the wireless receiver;
an event generator that generates events including location information;
a pattern matcher that matches generated events with known intrusion patterns; and
a controller coupled to the detector that controls access to the wireless network by a wireless device as a function of the matches.

11. The wireless network system of claim 10, wherein the event generator generates events that additionally includes security information about wireless devices attempting to access the network.

12. The wireless network system of claim 11 wherein the security information is selected from the group consisting of MAC address, timestamp, time span, traffic patterns, and exploitation attempts.

13. The wireless network system of claim 10 wherein location of a wireless device is a function of information obtained from multiple detectors.

14. The wireless network system of claim 13 wherein the location of a wireless device is determined by at least one of time difference of arrival, received signal strength and angle of arrival as detected from the multiple detectors.

15. The wireless network system of claim 10 and further comprising a dynamic intrusion reference model coupled to the pattern matcher for providing the known intrusion patterns.

16. The wireless network system of claim 10 and further comprising a map of physical space representing authorized areas.

17. A method of controlling access to a wireless network, the method comprising:
detecting a network access attempt by a wireless client device;
determining the location of the wireless client device; and
rejecting access by the wireless client device as a function of the location of the wireless client device.

18. The method of claim 17 wherein the access is also rejected as a function of security information related to the wireless client device.

19. The method of claim 17 wherein the security information is selected from the group consisting of MAC address, timestamp, time span, traffic patterns, and exploitation attempts.

20. The method of claim 17 wherein location of a wireless device is a function of information obtained from multiple location sensors.

21. The method of claim 17 wherein the location of a wireless device is determined by at least one of time difference of arrival, received signal strength and angle of arrival as detected from the multiple location sensors.
